(19) United States
(12) Patent Application Publication
(10) Pub. No.: US 2023/0163378 A1
(43) Pub. Date: May 25, 2023

(54) SYSTEMS AND METHODS FOR HEATING BATTERIES

(71) Applicant: Rivian IP Holdings, LLC, Plymouth, MI (US)

(72) Inventors: Boru Wang, Culver City, CA (US); Huthaifa Flieh, Santa Clara, CA (US); Chou Yeh, Torrance, CA (US); Laura Ochsner, Huntington Beach, CA (US); Kang Wang, Palos Verdes Estates, CA (US); Younes Sangsefidi, Irvine, CA (US)

(21) Appl. No.: 17/534,649

(22) Filed: Nov. 24, 2021

(51) Int. Cl. H01M 10/63; H01M 10/42; H01M 10/615; H01M 10/625; B60L 58/27; B60L 15/20; B60L 50/60; H02P 29/68

(52) U.S. Cl. CPC H01M 10/63; H01M 10/425; H01M 10/615; H01M 10/625; B60L 58/27; B60L 15/20; B60L 50/60; H02P 29/68; H01M 2010/4271; H01M 2220/20

(57) ABSTRACT

Various disclosed embodiments include illustrative controller units, drive units, and methods. In an illustrative embodiment, a controller unit includes a controller electrically couplable to an inverter and a memory configured to store computer-executable instructions. The computer-executable instructions are configured to cause the controller to receive a battery heat request value, receive a torque command, generate a motor command responsive to the battery heat request value and the torque command, and send the motor command to the inverter to facilitate delivery of heat to a battery to achieve a target temperature while also causing a motor associated with a drive unit to operate at a level of torque that corresponds to the torque command.

### INTRODUCTION

The present disclosure relates to electric vehicle battery management. The statements in this section merely provide background information related to the present disclosure and may not constitute prior art.

Battery-powered devices lose operational capabilities, such as battery life, when batteries operate outside an optimum temperature range. For example, electric vehicles may experience lower battery output when the vehicle is located in a cold environment. Costly battery heating devices are typically employed to maintain vehicle batteries at an acceptable temperature. Currently-known methods to heat vehicle batteries without a costly battery heating device can channel heat generated by a drive unit to a battery only during vehicle charging.

### BRIEF SUMMARY

Various disclosed embodiments include illustrative controller units, drive units, and methods.

In an illustrative embodiment, a controller unit of a vehicle includes a controller electrically couplable to an inverter and a memory configured to store computer-executable instructions. The computer-executable instructions are configured to cause the controller to receive a battery heat request value, receive a torque command, generate a motor command responsive to the battery heat request value and the torque command, and transmit the motor command to the inverter, wherein transmission of the motor command to the inverter facilitates delivery of heat to a battery associated with the vehicle to achieve a target temperature while also causing a motor associated with a drive unit to operate at a level of torque that corresponds to the torque command.

In another illustrative embodiment, a drive unit of a vehicle includes an inverter configured to receive direct current (DC) electrical power from a battery, an electric motor configured to receive three-phase alternating current (AC) electrical power from the inverter, a controller electrically couplable to the inverter; and a memory configured to store computer-executable instructions. The computer-executable instructions are configured to cause the controller to receive a battery heat request value, receive a torque command, generate a motor command responsive to the battery heat request value and the torque command, and transmit the motor command to the inverter, wherein transmission of the motor command to the inverter facilitates delivery of heat to the battery to achieve a target temperature while also causing the electric motor to operate at a level of torque that corresponds to the torque command.

In another illustrative embodiment, a method includes receiving a battery heat request value, receiving a torque command, generating a motor command responsive to the battery heat request value and the torque command, and transmitting the motor command to an inverter for an electric motor, wherein transmission of the motor command to the inverter facilitates delivery of heat to a battery to achieve a target temperature while also causing the electric motor to operate at a level of torque that corresponds to the torque command.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is a block diagram of an illustrative system.

FIG. 2 is a controller diagram of functions performed by controllers included in the system of FIG. 1.

FIG. 3 is a dq-axis current graph for driving a motor included in the system of FIG. 1.

FIG. 4 is a timing diagram of signals and values used by the system shown in FIG. 1.

FIG. 5 is a flow chart of an illustrative method performed by the system of FIG. 1.

FIG. 6 is a flow chart of details of the method of FIG. 5.

Like reference symbols in the various drawings generally indicate like elements.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various disclosed embodiments include illustrative controller units, drive units, and methods. In such embodiments, illustrative systems and methods may heat vehicle batteries at any time, when desired, in order to help contribute to a goal of improving operation of an electric vehicle and/or longevity and/or functionality of the batteries. The operations described below may occur during any operational state of a vehicle.

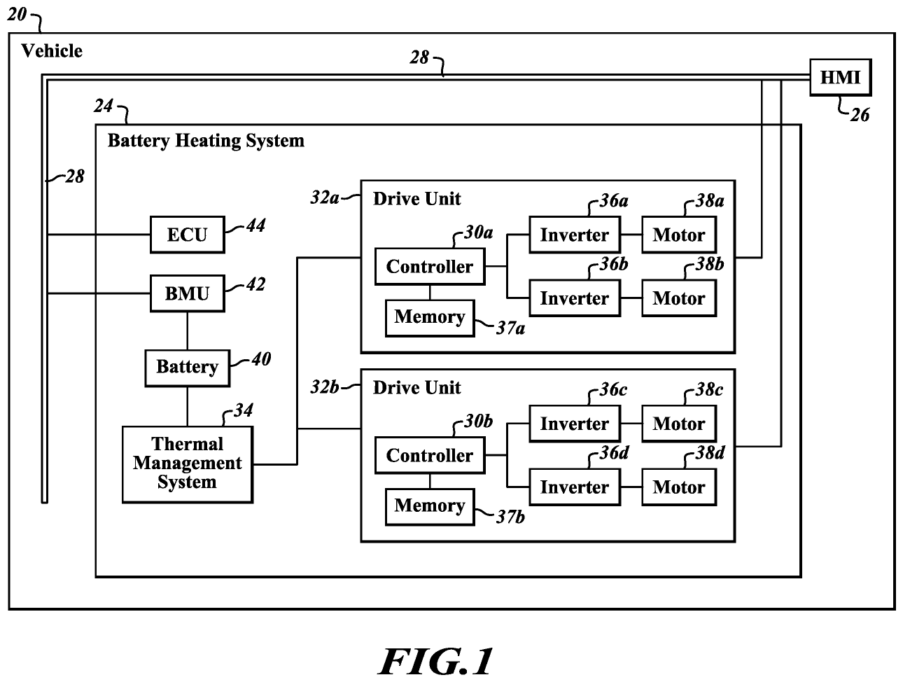

Given by way of non-limiting overview and referring to FIG. 1, in various embodiments a drive unit 32a or 32b includes an inverter 36a-36d configured to receive direct current (DC) electrical power from a battery 40, an electric motor 38a-38d configured to receive 3-phase alternating current (AC) electrical power from the inverter 36a-36d, a controller 30a or 30b electrically couplable to the inverter 36a-36d, and a corresponding non-transitory computer-readable medium, such as a memory 37a and 37b, configured to store computer-executable instructions. The instructions are configured to cause the controller to perform operations described herein. For example and as will be described below, in various embodiments the instructions are configured to cause the controller to receive a battery heat request value, receive a torque command, generate a motor command responsive to the battery heat request value and the torque command, and send the motor command to the inverter.

Still referring to FIG. 1, in various embodiments an illustrative vehicle 20 includes components for providing commanded torque and requested heat to electric motor controllers for use in generating heating batteries during vehicle use. The vehicle 20 includes one or more drive units 32a and 30b that are in data communication with an electronics control unit (ECU) 44, a battery management unit (BMU) 42, and a human-machine interface (HMI) 26, and in data and/or thermal communication with a thermal management system 34 and a battery 40 of the vehicle 20.

In various embodiments, the controller 30a or 30b and controllers in the ECU 44, the BMU 42, the HMI 26 herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software (e.g., a high-level computer program serving as a hardware specification) and or firmware would be well within the skill of one of skill in the art in light of this disclosure.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium (that is non-transitory medium) include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

As discussed above, various embodiments include the non-transitory computer-readable storage medium (that is, the memory 37a and 37b) having computer-readable code (instructions) stored thereon for causing the controller 30a or 30b to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include the instructions executable by the controller that, in response to such execution, causes performance of a set of operations, steps, methods, processes, algorithms, functions, techniques, etc. as described herein for the various embodiments.

In various embodiments the drive unit 32 includes the controller 30a or 30b, a pair of inverters 36a-36d, and a pair of alternating current (AC) 3-phase motors 38a-38d. A first one of the inverters 36a-36d receives DC electrical power from the battery 40 and converts the DC electrical power into 3-phase AC electrical power for a first one of the 3-phase AC electric motors 38a-38d. A second one of the inverters 36a-36d receives DC electrical power from the battery 40 and converts the DC electrical power into 3-phase AC electrical power for a second one of the 3-phase AC electric motors 38a-38d. The inverters 36a-36d generate the 3-phase current motor drive signals in response to instructions from the controller 30a or 30b.

It will be appreciated that the vehicle 20 may include any number of drive units (32a, 32b), controllers (30a, 30b), inverters (36a-36d), motors (38a-38d), and ECUs 44 as desired for a particular application. While FIG. 1 shows two drive units 32a and 32b, in various embodiments the vehicle 20 may include only one drive unit (32a or 32b) or, in various embodiments, the vehicle 20 may include additional drive units for controlling power to additional axles, shafts, and/or wheels or the like. While FIG. 1 shows one controller 30a or 30b operatively coupled to two inverters 36a-36d (each of which is, in turn, operatively coupled to an associated electric motor 38a-38d), in various embodiments a separate controller 30a and 30b may be operatively coupled to only one associated inverter 36a-36d (which is, in turn, operatively coupled to an associated electric motor 38a-38d). Thus, it will be appreciated that no limitation is to be inferred regarding the number of drive units 32a and 32b, controllers 30a and 30b, inverters 36a-36d, and electric motors 38a-38d that may be used in various embodiments.

In various embodiments the instructions are further configured to cause the controller 30a or 30b to receive a drive unit current value and a drive unit temperature value from the motor 38a-38d. The instructions further cause the controller 30a or 30b to generate an estimated heat value responsive to the drive unit current value and the drive unit temperature value. The instructions further cause the controller 30a or 30b to generate the motor command in further response to the torque command and a difference between the battery heat request value and the estimated heat value.

In various embodiments the instructions further cause the controller 30a or 30b to generate the estimated heat value in further response to a value chosen from a motor winding loss value, a motor magnet core loss value, an inverter loss value, and a heat transfer efficiency factor. The motor winding loss value, the motor magnet core loss value, the inverter loss value, and the heat transfer efficiency factor are values associated with details of each electric motor 38a-38d/inverter 36a-36d and are described in more detail below.

In various embodiments generation of the motor command further includes selecting a constant torque curve responsive to the torque command, determining a d-axis current value and a q-axis current value on the selected constant torque curve responsive to the difference between the battery heat request value and the estimated heat value, and transforming the d-axis current value and the q-axis current value into three-phase current values. The electric motor 38a-38d receives the three-phase current values. The relationship of torque in a d/q current reference frame is described in more detail below.

In various embodiments in an alternative to using the estimated heat value, the instructions are further configured to cause the controller or other controllers in the system 24 to receive a battery temperature value and generate the motor command in further response to the torque command and a difference between the battery heat request value and the battery temperature value.

In various embodiments the ECU 44, the BMU 42, the drive units 32a and 30b, and the HMI 26 may communicate with each other and with numerous other vehicle components via a network bus 28, such as a controller area network (CAN) bus. Other network buses, such as a local area network (LAN), a wide area network (WAN), or a value-added network (VAN), may also be used for enabling communication between the components connected to the network.

In various embodiments and given by way of example only and not of limitation, the battery 40 stores high voltage DC electrical power and provides the high voltage DC electrical power to the inverters 36a-36d that convert the high voltage DC electrical power to high voltage AC electrical power. The conversion of high voltage DC electrical power to high voltage AC electrical power and subsequent rotation of drive shaft by electrical motors is well known in the art and no further explanation is necessary for a person of skill in the art to understand disclosed subject matter.

It will be appreciated that heating the battery 40 may be desirable in various different scenarios. For example, in some embodiments the vehicle 20 may be located in a colder environment and the operator desires to operate the vehicle 20 while battery heating is occurring rather than later after battery pre-heating has completed. The operator of the vehicle 20 initiates a battery heat mode by selecting an input via the HMI 26. The battery heating mode may be defaulted to an always active state. In the battery heating mode, the BMU 42 may determine current temperature of the battery 40 and the BMU 42, ECU 44, or the thermal management system 34 may determine if there is a need to heat the battery 40 to a desired temperature. If there is a need to heat the battery 40, the BMU 42, ECU 44, or the thermal management system 34 facilitates transmission of a heat request (heat power request) to one or more of the drive units 32a and 30b. A heat request may include a target temperature value, a power (Watts) value, a rate of temperature increase, or the like. Simultaneously, the ECU 44 may generate a torque request responsive to an operational input from an operator via the HMI 26, such as, without limitation, an accelerator pedal. The ECU 44 may generate the torque request responsive to a speed control input from cruise control or autopilot functionality performed by the ECU 44 or another controller within the vehicle 20. In response to the one or more of the drive units 32a and 30b receiving the heat request and the torque request, the respective controllers 30 instruct the corresponding inverters 36a-36d to send 3-phase AC current values to the 3-phase AC electric motors 38a-38d. The 3-phase AC current values cause the 3-phase AC electric motors 38a-38d to operate at the requested torque value and produce heat according to the heat request. The operations of the controller 30a or 30b are described in more detail below.

In various embodiments upon receiving the heat request, the controller 30a or 30b of one of the drive units 32a and 30b instructs one or both of the associated inverters 36a-36d and motors 38a-38d to produce a particular amount of heat that is needed for the battery, while also producing the torque as per the requested torque value.

In various embodiments the BMU 42 ECU 44, or the thermal management system 34 generates a heat request if the battery temperature information received from the battery 40 is below a threshold value. The BMU 42 determines the threshold value based on an operation mode of the vehicle.

Upon receiving the determination to heat the battery 40 or receiving notification that a battery heat mode has begun, the thermal management system 34 may be a closed loop system having a pumps, valves, ducting, heat transfer units, heat-transfer fluid, etc. The heat-transfer fluid may be a liquid or gas or may transition between a liquid or gas as the heat heat-transfer fluid moves between heat attaining and heat dissipating sections of the closed loop system. Thermal management systems are well known in the art and no further explanation is necessary for a person of skill in the art to understand disclosed subject matter. The thermal management system 34 controls transfer of heat from one or more drive units 32a and 32b to the battery 40 by sending control signals to the included pumps or valves that control the flow of the heat-transfer fluid. Heat is transferred from the associated inverters 36a-36d and/or the 3-phase AC electric motors 38a-38d by heated heat-transfer fluid to a location at or near the battery 40, whereby heat from the heated heat-transfer fluid is dissipated into the battery 40. Referring back to FIG. 1, lines connected between the thermal management system 34, the battery 40, and the drive units 32 represent conduit used for transmitting the heat-transfer fluid between the components. Examples of the thermal management system 34 may be a single, closed-loop system or may include components of a battery coolant system and/or a drive unit coolant system (that is, a drivetrain coolant system). Once the battery 40 has reached a desired temperature, as determined by the thermal management system 34 or other component, a signal is sent back to the BMU 42, and/or the drive units 32a and 30b instructing the battery heating to stop.

In various embodiments and given by way of example only and not of limitation, the battery 40 suitably includes high energy rechargeable batteries that store electrical charge, discharge electrical current upon request, and recharge with a power source. The battery 40 may be structured in any desirable form, such as, without limitation, cylindrical, pouch, prismatic, massless, or other comparable forms. In various embodiments the battery 40 includes Li-ion batteries, such as, without limitation, Nickel Cobalt Aluminum, Lithium Manganese Cobalt, or Lithium Manganese Oxide batteries.

In various embodiments and given by way of example only and not of limitation, the HMI 26 may include mechanical buttons or switches or may include selectable graphical user interface features presented on a vehicle display device(s). The HMI 26 may receive input, such as a request to activate battery heating operation, from the operator and send that input to the ECU 44, the BMU 42, the thermal management system 34, and/or the drive units 32a and 30b.

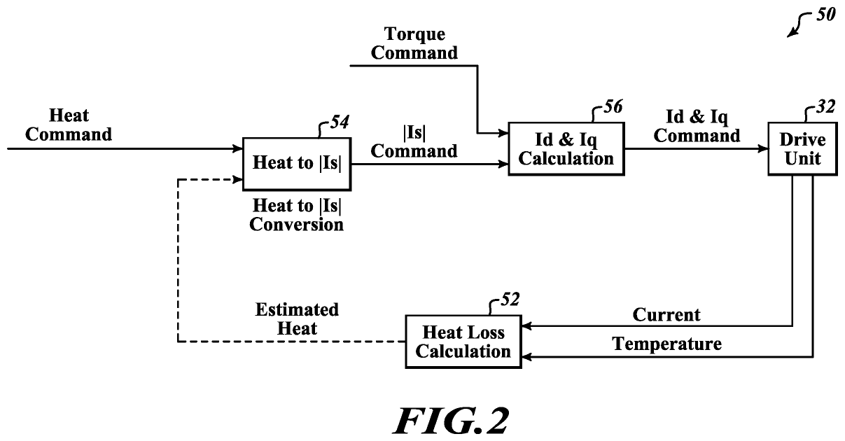

Referring additionally to FIG. 2, in various embodiments a control diagram 50 includes operations performed by the controller 30a or 30b, the ECU 44, the BMU 42, and/or the thermal management system 34. The device performing the operations receives a heat request/command from the BMU 42 or the thermal management system 34. The heat request may be calculated based on a target temperature rise within defined amount of time. In various embodiments at a block 54 a heat request is converted to a current magnitude |Is| command. The device performing the operations may use a drive unit current magnitude |Is| and a drive unit temperature(s) to calculate various values (motor winding loss value, a motor magnet core loss value, and/or an inverter loss value) that are used with the heat request/command from the BMU 42 to determine an magnitude of AC current |Is| command. This may be performed using a look-up table or comparable computational method.

In various embodiments an estimated heat is optionally determined by a combination of winding loss (Loss_{winding}), core loss (Loss_{core}), inverter loss (Lossᵢₙᵥₑᵣₜₑᵣ), and heat transfer efficiency (ηₕₑₐₜ).

Loss_{winding} is loss (in Watts) from phase windings of the 3-phase AC electric motor 38a-38d. In one embodiment, Loss_{winding} depends on current magnitude and motor temperature. Loss_{winding}=I²×R, where I is magnitude of current flowing through each phase (Iₐ, I_{b} and I_{c}), and R is the temperature-dependent resistance of phase windings.

Loss_{core} is loss (in Watts) from the magnet core of the 3-phase AC electric motor 38a-38d. Loss_{core} depends on current magnitude |Is| and motor speed the from an encoder comparable speed sensor within the 3-phase AC electric motor 38a-38d. Loss_{core} may be determine as follows:

Loss_{core}∝B^{α}f^{b}

B is the magnetic field within the core which is current magnitude dependent. f is the frequency of the magnetic field swing, which is proportional to motor speed. Coefficients a and b are empirically determined.

Determination of Loss_{core} is well known in the art and no further explanation is necessary for a person of skill in the art to understand disclosed subject matter.

LOSSᵢₙᵥₑᵣₜₑᵣ is loss (in Watts) from inverter current conduction and switching actions within the inverter 36a-36d. In accordance with one implementation, Lossᵢₙᵥₑᵣₜₑᵣ depends on current magnitude |Is| and drive unit DC inverter temperature. Lossᵢₙᵥₑᵣₜₑᵣ is a combination of conduction loss (Loss_{conduction}) switching loss (Loss_{switching}), R_{semiconductor}, V_{semiconductor}, f_{switching}, and E_{switching}, and duty cycle dependent factors.

Loss_{conduction} is the loss due to the current conducted thru the semiconductor. In accordance with one example, the R_{semiconductor} and V_{semiconductor} are affected by drive unit temperature, semiconductor temperature, current magnitude, effective resistance, and forward voltage drop.

Loss_{switching} is the loss due to switching action of semiconductor. The f_{switching} is the semiconductor switching frequency, a value determined by the drive unit controller 30a or 30b. E_{switching} is the energy loss during one switching event, and its value depends on current and drive unit temperature. The f_{switching} and E_{switching} may also be affected by semiconductor temperature, current magnitude, and switching frequency. Determination of Lossᵢₙᵥₑᵣₜₑᵣ is well known in the art and no further explanation is necessary for a person of skill in the art to understand disclosed subject matter.

ηₕₑₐₜ is a ratio between heat transferred to battery and loss generated from drive unit. Determination of ηₕₑₐₜ is well known in the art and no further explanation is necessary for a person of skill in the art to understand disclosed subject matter.

In various embodiments, the controller 30a or 30b may optionally determine the difference between the heat request and the estimated heat. The difference of the heat request and the estimated heat is fed into a PI controller to compute the drive unit AC current magnitude value |Is|. In an alternative design, the controller 30a or 30b calculates the current magnitude value from heat request in an open-loop control manner. The current magnitude value may be calculated using other control methods not limited to look-up table, curve fitting and theoretical equations.

Concurrently, the controller 30a or 30b receives a torque request from the ECU 44. A torque request of zero or no torque request would mean the vehicle is stopped and possibly charging. In a regenerative braking mode of operation, the controller 30a or 30b receives a torque command that is negative to the motor rotation direction as well as a heat command. The controller 30a or 30b then computes the Id & Iq command the same way as shown in FIG. 2.

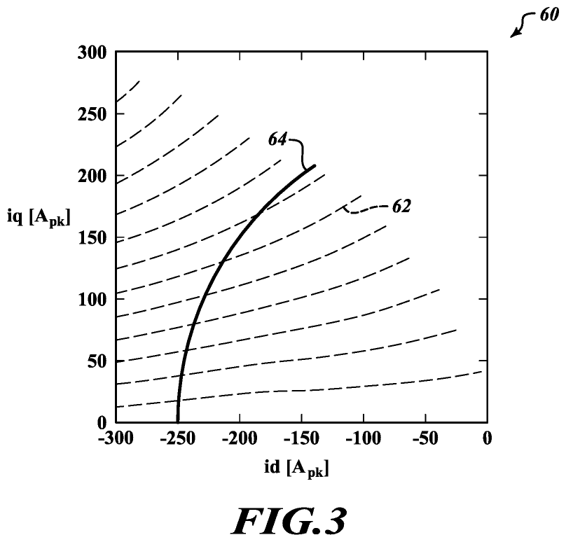

At an Id and Iq calculation function 56, the current magnitude |Is| and the torque request are transformed to Id and Iq values. The transformation may be performed using a look-up table that correlates with an Id value and an Iq torque curve, such as that of FIG. 3. The Id and Iq values are transformed into 3-phase current values that are sent to the 3-phase AC electric motor 38a-38d within the drive unit 32. The transformed Id and Iq current values cause the 3-phase AC electric motor 38a-38d to produce the requested amount of torque and the requested amount of heat.

Referring additionally to FIG. 3, the controller 30a or 30b causes the 3-phase AC electric motor 38a-38d to produce torque by controlling the magnitude of AC current vector |Is|. The current vector may be described within a d-q coordinate system (that is, the d-axis current (Id) and q-axis current (Iq)) 60. In geometric terms, the “d” and “q” axes are the single-phase representations of the flux contributed by the three separate sinusoidal phase quantities at the same angular velocity. The d-axis, also known as the direct axis, is the axis by which flux is produced by the permanent magnet. The q-axis, the quadrature axis, is the axis on which torque is produced. In simplistic terms, the d-axis is the main flux direction, while the q-axis is the main torque producing direction.

Each of curves 62 within the d-q coordinate system 60 identifies a constant torque motor output. Under normal driving conditions where energy efficiency is valued, the goal of the controller 30a or 30b is to regulate torque while minimizing amount of loss. Since loss has a positive correlation with the current vector magnitude (|Is|=\sqrt{I_{d}²+I_{q}²}, the Id and Iq combination resulting in minimal current vector magnitude |Is| is selected to achieve any level of torque command. In order to perform battery heating, the controller 30a or 30b regulates heat loss in addition to torque. The desired current vector magnitude |Is| value based on target heat loss level is first computed. This is shown as a line 64 in the d-q coordinate system 60. Then, the Id and Iq values to achieve the target torque level are identified (that is, the curve 62). The intersection of the line 64 and the curve 62 produces the desired current vector magnitude |Is|.

In various embodiments and given by way of example only and not of limitation, converting values between the dq reference frame to the 3-phase current frame (abc reference frame) may be performed by a transformation matrix, known as the Park's transformation matrix and the inverse Park's transformation matrix. The dq reference frame is used for more easily performing calculations on the signals and independently controlling the active (d-axis) and reactive (q-axis) components on current and voltage. Transformation operations are well known in the art and no further explanation is necessary for a person of skill in the art to understand disclosed subject matter.

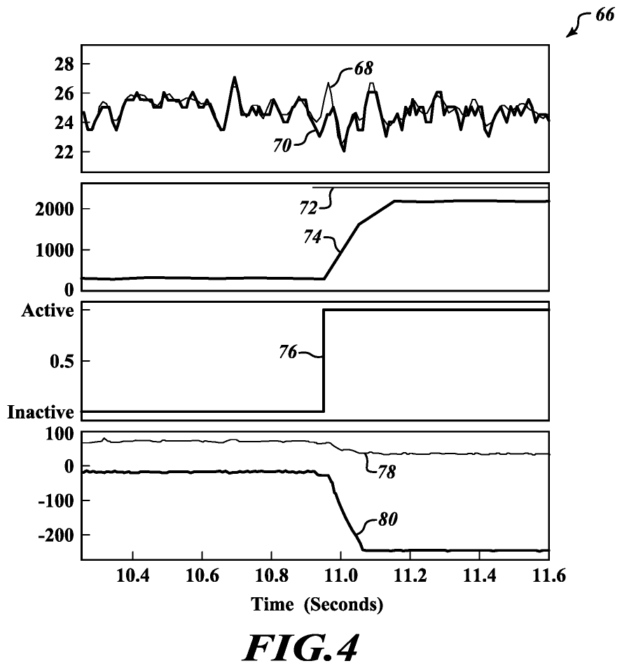

Referring additionally to FIG. 4, in various embodiments a timing diagram 66 includes a commanded Id value 80, a commanded Iq value 78, an activate battery heating signal 76, a heat/loss value 74, a commanded heat/loss value 72, a torque command signal 68, and a torque output signal 70. Given by way of non-limiting example, at a time (such as, for example and without limitation, 10.8 seconds) before the vehicle 20 is placed in a normal driving condition, an activate battery heating signal 76 is in an off state and the commanded Id value 80 and commanded Iq value 78 are selected according to the torque command signal 68 received from the ECU 44. The torque output signal 70 matches the torque command signal 68. Also, the heat/loss value 74 of the 3-phase AC electric motor 38a-38d is minimized for efficiency. At a time after the activate battery heating signal 76 has been activated (such as, for example and without limitation, after 10.8 s), battery heating begins. The commanded Id value 80 and the commanded Iq value 78 change to provide for greater heat/loss for delivery to the battery 40. The torque output signal 70 still matches the torque command signal 68. The heat/loss value 74 increases to match or nearly match the commanded heat/loss value 72.

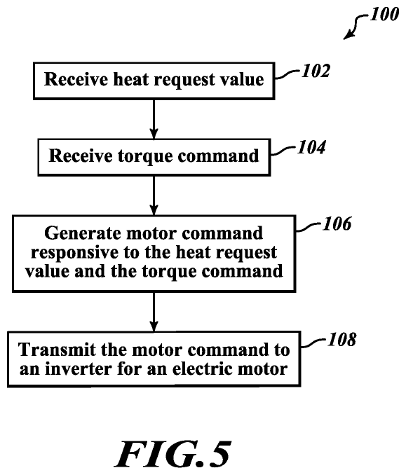

Referring additionally to FIG. 5, in various embodiments an illustrative method 100 is provided for a controller of a drive unit. It will be appreciated that, in some embodiments the method 100 may be suited for being performed by a controller executing instructions stored in a memory. At a block 102, at least one controller receives a heat request value. At a block 104, the at least one controller receives a torque command. At a block 106, the at least one controller generates a motor command responsive to the heat request value and the torque command. At a block 108, the at least one controller sends the motor command to an inverter for an electric motor. According to one example, a single drive unit and associated controller, inverter and electric motor may be used to accomplish the heat transfer operation for the battery, or alternatively, and based on the target temperature, multiple drive units may work in the tandem to facilitate transfer of sufficient heat to the battery.

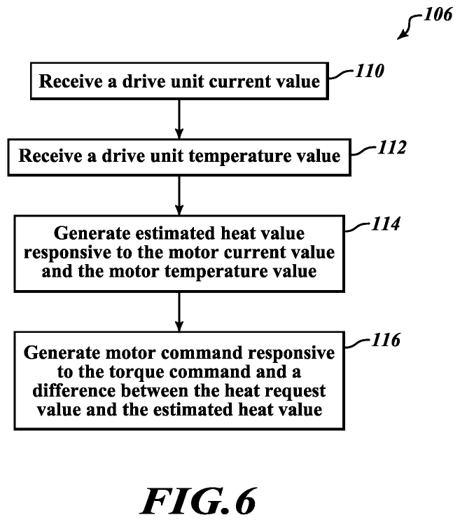

Referring additionally to FIG. 6, in various embodiments generating a motor command responsive to the heat request value and the torque command at the block 106 (FIG. 5) may entail various illustrative operations. For example, in various embodiments at a block 110, the controller, such as a drive unit controller, a BMU, or the like, receives a drive unit current value(s). At a block 112, the controller receives a drive unit temperature value(s). At a block 114, the controller generates an estimated battery heat value responsive to the drive unit current value and the drive unit temperature value. At a block 116, the generation of the motor command is further responsive to the torque command and a difference between the battery heat request value and the estimated heat value.

The term controller, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of controller (e.g., at a first time), as a second type of controller (e.g., at a second time, which may in some instances coincide with, overlap, or follow a first time), and/or as a third type of controller (e.g., at a third time which may, in some instances, coincide with, overlap, or follow a first time and/or a second time), etc. Reconfigurable and/or controllable components (e.g., general purpose processors, ASICs, DSPs, FPGAs, etc.) are capable of being configured as a first controller that has a first purpose, then a second controller that has a second purpose and then, a third controller that has a third purpose, and so on. The transition of a reconfigurable and/or controllable component may occur in as little as a few nanoseconds, or may occur over a period of minutes, hours, or days.

In some such examples, at the time the controller is configured to carry out the second purpose, the controller may no longer be capable of carrying out that first purpose until it is reconfigured. A controller may switch between configurations as different components/modules in as little as a few nanoseconds. A controller may reconfigure on-the-fly, e.g., the reconfiguration of a controller from a first controller into a second controller may occur just as the second controller is needed. A controller may reconfigure in stages, e.g., portions of a first controller that are no longer needed may reconfigure into the second controller even before the first controller has finished its operation. Such reconfigurations may occur automatically, or may occur through prompting by an external source, whether that source is another component, an instruction, a signal, a condition, an external stimulus, or similar.

For example, a central processing unit or the like of a controller may, at various times, operate as a component/module for displaying graphics on a screen, a component/module for writing data to a storage medium, a component/module for receiving user input, and a component/module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple components/modules, the example includes the possibility that the same hardware may implement more than one of the recited components/modules, either contemporaneously or at discrete times or timings. The implementation of multiple components/modules, whether using more components/modules, fewer components/modules, or the same number of components/modules as the number of components/modules, is merely an implementation choice and does not generally affect the operation of the components/modules themselves. Accordingly, it should be understood that any recitation of multiple discrete components/modules in this disclosure includes implementations of those components/modules as any number of underlying components/modules, including, but not limited to, a single component/module that reconfigures itself over time to carry out the functions of multiple components/modules, and/or multiple components/modules that similarly reconfigure, and/or special purpose reconfigurable components/modules.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any to patentable subject matter under 35 U.S.C. 101.

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. A controller unit of a vehicle comprising:
a controller electrically couplable to an inverter; and
a memory configured to store computer-executable instructions configured to cause the controller to:
receive a battery heat request value;
receive a torque command;
generate a motor command responsive to the battery heat request value and the torque command; and
transmit the motor command to the inverter, wherein transmission of the motor command to the inverter facilitates delivery of heat to a battery associated with the vehicle to achieve a target temperature while also causing a motor associated with a drive unit to operate at a level of torque that corresponds to the torque command.

2. The controller unit of claim 1, wherein:
the instructions are further configured to cause the controller to:
receive a drive unit current value;
receive a drive unit temperature value; and
generate an estimated heat value responsive to the drive unit current value and the drive unit temperature value; and
wherein generating the motor command is further responsive to the torque command and a difference between the battery heat request value and the estimated heat value.

3. The controller unit of claim 2, wherein generating the estimated heat value is further responsive to a value chosen from a motor winding loss value, a motor magnet core loss value, and a heat transfer efficiency factor.

4. The controller unit of claim 3, wherein generating a motor command further includes:
determining a first current value and a second current value responsive to the torque command and the difference between the battery heat request value and the estimated heat value; and
transforming the first current value and the second current value into three-phase current values.

5. The controller unit of claim 1, wherein:
the instructions are further configured to cause the controller to receive a battery temperature value; and
generating the motor command is further responsive to the torque command and a difference between the battery heat request value and the battery temperature value.

6. The controller unit of claim 5, wherein generating a motor command further includes:
determining a first current value and a second current value responsive to the torque command and the difference between the battery heat request value and the battery temperature value; and
transforming the first current value and the second current value into three-phase current values.

7. A drive unit of a vehicle comprising:
a first inverter configured to receive direct current (DC) electrical power from a battery;
a first electric motor configured to receive three-phase alternating current (AC) electrical power from the inverter;
a controller electrically couplable to the inverter; and
a memory configured to store computer-executable instructions configured to cause the controller to:
receive a battery heat request value;
receive a torque command;
generate a motor command responsive to the battery heat request value and the torque command; and
transmit the motor command to the inverter, wherein transmission of the motor command to the first inverter facilitates delivery of heat to a battery associated with the vehicle to achieve a target temperature while also causing the first electric motor to operate at a level of torque that corresponds to the torque command.

8. The drive unit of claim 7, wherein:
the instructions are further configured to cause the controller to:
receive a drive unit current value;
receive a drive unit temperature value; and
generate an estimated heat value responsive to the drive unit current value and the drive unit temperature value; and
wherein generating the motor command is further responsive to the torque command and a difference between the battery heat request value and the estimated heat value.

9. The drive unit of claim 8, wherein generating the estimated heat value is further responsive to a value chosen from a motor winding loss value, a motor magnet core loss value, and a heat transfer efficiency factor.

10. The drive unit of claim 9, wherein generating a motor command further includes:
determining a first current value and a second current value responsive to the torque command and the difference between the battery heat request value and the estimated heat value; and
transforming the first current value and the second current value into three-phase current values.

11. The drive unit of claim 7, wherein:
the instructions are further configured to cause the controller to receive a battery temperature value; and
generating the motor command is further responsive to the torque command and a difference between the battery heat request value and the battery temperature value.

12. The drive unit of claim 11, wherein generating a motor command further includes:
determining a first current value and a second current value responsive to the torque command and the difference between the battery heat request value and the battery temperature value; and
transforming the first current value and the second current value into three-phase current values.

13. The drive unit of claim 11, further comprising:
a second inverter configured to receive DC electrical power from the battery;
a second electric motor configured to receive three-phase AC electrical power from the second inverter,
wherein the instructions are further configured to cause the controller to:
send the second electric motor command to the second inverter.

14. A method comprising:
receiving a battery heat request value;
receiving a torque command;
generating a motor command responsive to the battery heat request value and the torque command; and
transmitting the motor command to an inverter for an electric motor, wherein transmission of the motor command facilitates delivery of heat to a battery to achieve a target temperature while also causing the electric motor to operate at a level of torque that corresponds to the torque command.

15. The method of claim 14, further comprising:
receiving heat generated by a device chosen from the inverter and the motor; and
transferring the heat to a battery.

16. The method of claim 14, further comprising:
receiving a drive unit current value;
receiving a drive unit temperature value;
generating an estimated battery heat value responsive to the drive unit current value and the drive unit temperature value,
wherein generating the motor command is further responsive to the torque command and a difference between the battery heat request value and the estimated heat value.

17. The method of claim 16, wherein generating the estimated heat value is further responsive to a value chosen from a motor winding loss value, a motor magnet core loss value, and a heat transfer efficiency factor.

18. The method of claim 16, wherein generating a motor command further includes:
determining a first current value and a second current value responsive to the torque command and the difference between the battery heat request value and the estimated heat value; and
transforming the first current value and the second current value into three-phase current values.

19. The method of claim 14, further comprising:
receiving a battery temperature value,
wherein generating the motor command is further responsive to the torque command and a difference between the battery heat request value and the battery temperature value.

20. The method of claim 19, wherein generating a motor command further includes:
determining a first current value and a second current value responsive to the torque command and the difference between the battery heat request value and the battery temperature value; and
transforming the first current value and the second current value into three-phase current values.
